(19) United States
(12) Patent Application Publication
(10) Pub. No.: US 2007/0091296 A1
(43) Pub. Date: Apr. 26, 2007

(54) Article and method of assessing source authenticity for an opaque colored part

(75) Inventors: Christopher L. Hein, Evansville, IN (US); Kenneth F. Miller, Mt. Vernon, IN (US); Jeffrey S. Pharr, Mt. Vernon, IN (US)

Correspondence Address: GEAM - O8CV - CPP;IP LEGAL, ONE PLASTICS AVENUE, PITTSFIELD, MA, 01201-3697, US

(73) Assignee: General Electric Company

(21) Appl. No.: 11/258,461

(22) Filed: Oct. 25, 2005

(51) Int. Cl. G06K 9/74

(52) U.S. Cl. 356/71

(57) ABSTRACT

An article includes a colorant system which may be assessed for authenticity by assessing the visual color of a part and comparing the visual color of the authorized specific color to see if there is a color match and measuring a non-visible electromagnetic reflectance spectrum or portion thereof of the said part and comparing it to the authorized non-visible electromagnetic reflectance spectrum or portion thereof to see if there is an appropriate reflectance match.

### BACKGROUND OF THE INVENTION

Advances in technology have brought forth various new products, which are highly sought in the entertainment field as well as more traditional areas of business. Many of these products require a high degree of performance from its various parts or single article. However, there generally is no quick way for the ultimate user, distributor or manufacturer to quickly assess whether or not these part(s) will perform as they are represented. Rather, genuine part(s) are being replaced by “knock off” part(s), supplied by unapproved vendors, which look genuine, are usually significantly lower priced and overall strikingly similar to the genuine part(s) supplied by an approved vendor. However, only after a period of time has passed is it observed that these part(s) do not perform as they are touted. These “knockoff” inferior materials from which part(s) for products are processed have become a significant worldwide business. Particular products for which knockoffs have experienced special “success” include DVD, plastic cards, molded case circuit breakers, electronic enclosures, and battery covers as well as many others. The revenue loss due to counterfeited parts costs plastics processors millions of dollars. No one in the products distribution channel is satisfied with this state of affairs, including the materials manufacturer, the parts processor, the product assembler, the retailer, and ultimately, the end user.

What is needed to prevent this kind of costly deception is a rapid, accurate, inexpensive method to ascertain if the material or processed part(s) is from an approved supplier of that part.

### SUMMARY OF THE INVENTION

In accordance with the invention, there is a method for assessing the authenticity of a colored part, which comprises

a. assessing the visual color of a part and comparing to the authorized specified color to see if there is an appropriate color match,

b. measuring a non-visible electromagnetic reflectance spectrum or portion thereof of the said part and comparing it to the authorized non-visible electromagnetic reflectance spectrum or portion thereof to see if there is an appropriate reflectance match.

In this manner, the authenticity of the supplied material or supplied part can be assessed.

### BRIEF DESCRIPTION OF DRAWINGS

FIGS. 1 through 5 are the reflectance spectra of respective green, blue I, blue II, red and black for samples.

### DETAILED DESCRIPTION OF THE INVENTION

It should be noted that throughout the specification the term “part” is employed. However, the deception can appear at the material level from which a part is prepared. Additionally, the word “part” includes any physical manifestation of the materials for which reflectance can be measured. An example of this is reflectance measurements on extruded pellets. Therefore the invention lies in measuring the reflectance of the part, but the material from which the part is prepared is where the actual deception can commonly occur.

It has now been discovered that the part electromagnetic spectrum can be analyzed to identify the source of the part. Any part that has a specified visible color also has a non-visible electromagnetic reflectance fingerprint. Generally, there are many ways in which a certain visible color can be prepared and matched to a specified visible color. Various combinations of pigments and/or dyes can be employed to achieve that color match. The visible color does not commonly differentiate a genuine from a non-genuine article.

Although matched in the visible spectrum, each one of these combinations can have its own telltale fingerprint in other portions of the electromagnetic spectrum, particularly the IR portion. Through specific reflectance in other non-visible portions of the spectrum, the source of the part can be authenticated as approved or non-approved for genuineness. For example, through use of an appropriate instrument, the IR reflectance value can be obtained by any party who processes the material or assembles molded parts [or their designee.] If this value is a matching value to the approved part or material supplier value, then the material or part is genuine and should perform as expected in the product. Counterfeiting various products, part(s) of products and materials which go into products has become a major worldwide problem for entities involved in the distribution chain of a product. Such counterfeiting tarnishes the reputation of the manufacturer, distributor and others within the distribution chain of the product. Although parts and materials are usually well specified, many of these specifications are end product specifications. In the modern business climate of low inventories, essentially ship in and use “immediately,” there is very little time to check out a new supplier's credentials as to the particular part. A rapid, inexpensive and accurate test which is specific to known acceptable performance specifications is needed.

Most parts or materials to be processed require a custom color. However, the colorants (pigments and/or dyes) also have a telltale “fingerprint” in the non-visible spectrum. Obtaining a certain visible color generally can be done using a variety of different combinations of colorants. Each of these combinations provides a “color match” in the visual spectrum. However, each combination can further provide significantly different spectra in non-visible areas of the spectrum such as the infrared, ultraviolet, and microwave as well. Reflectance measurements are used since the parts are generally opaque or sufficiently opaque for reflectance measurements to be used.

Various colors can be formulated by employing the techniques of this specification. These colors include white, black, gray, primary colors (red, yellow, and blue), secondary colors (for example orange, green and violet), and tertiary intermediate colors formed from mixtures of one primary and one secondary color.

A specific wavelength, or series of wavelengths, provides a marker which is used to distinguish various parts as to source, thereby authenticating the part or material that makes up the part. This value, or series of values, can be made part of the desired specification so as to identify counterfeit goods not having such values. This marker is not a different material inserted into the article merely for the purpose of authentication; it is part of the color property of the product and does not require additional equipment for activation. There are no prohibitions against any processing variables such as processing temperatures. It is a part of the color package and is preferably a pigment.

The non-visible reflectance spectra can be measured using spectrographs effective in the desired electromagnetic region. For example, in the infrared region, infrared spectrophotometry can be used for reflectance measurements.

As noted previously, any portion or all of the non-visible spectrum of light reflectance complex can be employed. However, the IR, particularly the near IR is preferred. The cost of measuring the spectrum through proper instrumentation can be quite costly. Spectrophotometers for the IR, particularly the near IR, are moderately priced and can be employed effectively. Instruments such as Perkin Elmer Lambda 35 or Lambda 900 can be used to measure IR reflectance spectrum. By IR, it is meant the spectrum obtained between about 700 nm and about 50 mm. The near IR is generally thought to be from about 700 nm to about 2500 nm. The thermal IR is between about 2500 nm and 15,000 nm. The far IR is between 15 and 50 mm. Moderately priced spectrophotometers are capable up to 1000 nm. As is shown in the figures, various combinations of colorants can give close color matches in the visible range but give widely divergent values in the near IR spectrum.

The present invention is demonstrated in polybutylene terepthalate and a polycarbonate/polyester blend. However, other possible polymers which can be applied to the present invention include, but are not limited to, amorphous, crystalline and semi-crystalline thermoplastic materials: polyvinyl chloride, polyolefins (including, but not limited to, linear and cyclic polyolefins and including polyethylene, chlorinated polyethylene, polypropylene, and the like), polyesters (including, but not limited to polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate, methyl methacrylate-polyimide copolymers, and the like), polyacrylonitrile, polyacetals, polycarbonates, polyester carbonates, resorcinol polyarylates polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, Teflons, as well as thermosetting resins such as epoxy, phenolic, polyester, polyimide, polyurethane, mineral filled silicone, bis-maleimides, cyanate esters, vinyl, and benzocyclobutene resins, in addition to blends, copolymers, mixtures, reaction products and composites comprising at least one of the foregoing plastics.

The total pigment loading for inorganic and organic pigments in the present invention can vary from 0.001% to 20% (weight percent).

The parts produced from polymers of the present invention can be produced using the following non-inclusive methods: injection molding, extruded pellets, film casting, extrusion, rotational molding, compaction molding, thermoforming, blow molding, stamping, film cast and combinations. Articles made from these methods can be opaque or translucent wherein their non-visible spectra can be measured using reflectance spectroscopy. Therefore, the term opaque in this specification and claims includes traditional opaque as well as any degree of translucency for which one can obtain an appropriately measurable reflectance value.

Inorganic pigments which may be utilized in the present invention include, metal oxides and oxide-hydroxides, mixed metal oxides, titanates, aluminates, carbonates, iron oxides, chromium oxides, ultramarines and metal sulfides, sulfoselenides, rare-earth sulfides, chromium iron oxides, chromium iron nickel spinel, chromium green-black hematite, bismuth vanadate, chromates, nitrides (including, but not limited to tantalum), iron blue, cobalt and manganese phosphates, and carbon black.

Organic colorants which may be utilized in the present invention include organic dyes and pigments such as azo dyes, methine dyes, coumarins, pyrazolones, quinophthalones, quinacridones, perinones, anthraquinones, phthalocyanines, perylene derivatives, anthracene derivatives, indigoid and thioindigoid derivatives, imidazole derivatives, napthalimide derivatives, xanthenes, thioxanthenes, azine dyes, rhodamines, and all their derivatives.

Below are examples of the invention utilizing various color compositions; green, blue, red, and black opaque colors. The non-visible spectrum measured is the near IR.

For a given color, multiple compositions were formulated to give a good visual and numerical color match while allowing good separation in the infrared. Below is Table 1 referencing the different colorants employed to obtain color matches.

TABLE 1

| | | | | Pigment | | |
|---|---|---|---|---|---|---|
| | | | | Trade | | |
| Code | Color index | Classification | Color Family | Name | Manufacturer | CAS No. |
| A | Pigment | Titanium Dioxide | White | | | 13463-67-7 |
| | White 7 | | | | | |
| B | Pigment | Carbon Black | Black | Monarch ® | Cabot | 1333-86-4 |
| | Black 7 | | | 800 | | |
| C | Pigment | Carbon Black | Black | Black | Cabot | 1333-86-4 |
| | Black 7 | | | Pearls ® | | |
| | | | | 800 | | |
| D | Pigment | Chromium Iron | Black/Brown | Black 411A | Shepherd | 12737-27-8 |
| | Brown 29 | Oxide | | | | |
| E | Pigment | Chrome Iron | Black | Black 376A | Shepherd | 71631-15-7 |
| | Black 30 | Nickel Spinel | | | | |
| F | Pigment | Manganese | Brown | Sicotan ® | BASF | 68412-38-4 |
| | Yellow 164 | Antimony | | Brown | | |
| | | Titanium Buff | | K 2750 FG | | |
| | | Rutile | | | | |
| G | Pigment | Manganese | Brown | Sicotan ® | BASF | 68412-38-4 |
| | Yellow 164 | Antimony | | Brown | | |
| | | Titanium Buff | | K 2711 | | |
| | | Rutile | | | | |
| H | Pigment | Manganese | Brown | Sicotan ® | BASF | 68412-38-4 |
| | Yellow 164 | Antimony | | Brown | | |
| | | Titanium Buff | | K 2611 | | |
| | | Rutile | | | | |
| I | Pigment | Manganese | Brown | Brown | Shepherd | 68412-38-4 |
| | Yellow 164 | Antimony | | 10P850 | | |
| | | Titanium Buff | | | | |
| | | Rutile | | | | |
| J | Pigment | Manganese | Brown | Auburn 153 | Shepherd | 68412-38-4 |
| | Yellow 164 | Antimony | | | | |
| | | Titanium Buff | | | | |
| | | Rutile | | | | |
| K | Pigment | Magnesium | Brown | Mapico ® | Rockwood | 12068-86-9 |
| | Brown 11 | Ferrite | | 20A | | |
| L | Pigment | Chromium Oxide | Green | | | 1308-38-9 |
| | Green 17 | | | | | |
| M | Pigment | Cobalt Chromite | Green/Blue | | | 68187-11-1 |
| | Green 36 | Blue-Green | | | | |
| | | Spinel | | | | |
| N | Pigment | Ultramarine Blue | Blue | | | 57455-37-5 |
| | Blue 29 | | | | | |
| O | Solvent | Perinone | Red | | | 20749-68-2 |
| | Red 135 | | | | | |
| P | Solvent | Pyrazolone | Yellow | | | 4702-90-3 |
| | Yellow 93 | | | | | |
| Q | Solvent | Anthraquinone | Green | | | 128-80-3 |
| | Green 3 | | | | | |

Below are examples showing compositions of various samples with visible color matches.

### EXAMPLE 1

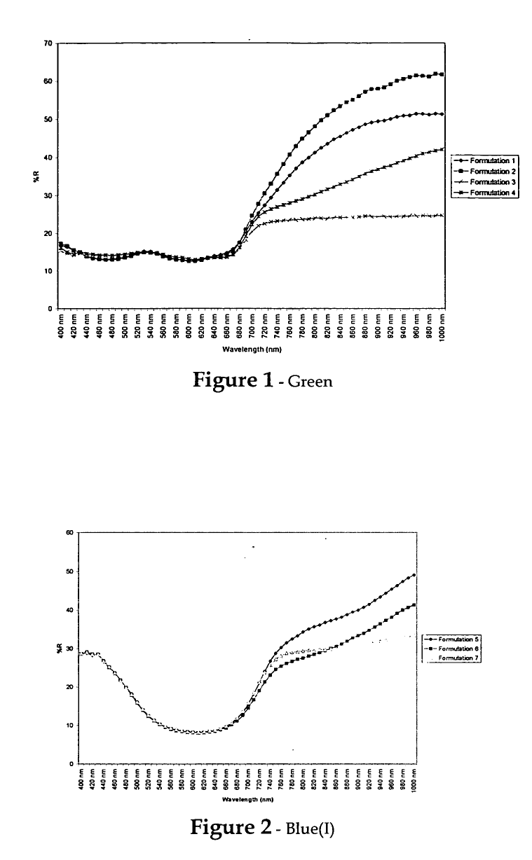

It was found that multiple formulations, for a low chroma green, were possible through use of manganese rutile brown, chromium iron oxides, and carbon black. One or more of each pigment was combined with other inorganic pigments to produce a visible match with dE CMC<1.2 (Table 2,7). While visible color remained constant, reflectance in the infrared was quite different among these batches with a range of reflectance values from 24.6% R to 51.1% R at 980 nm (FIG. 1).

TABLE 2
Green

| Valox ® 325 | | | | |
|---|---|---|---|---|
| PBT | 1 | 2 | 3 | 4 |
| A | 0.100 | 0.105 | 0.125 | 0.125 |
| L | 0.215 | 0.215 | 0.011 | 0.011 |
| M | 0.325 | 0.225 | 0.525 | 0.580 |
| F | 0.310 | | | |
| G | | 0.470 | | |
| H | | | 0.680 | 0.640 |
| E | | | 0.072 | |
| B | | | | 0.010 |

### EXAMPLE 2

Two different blue colors were formulated. The first blue(I) was formulated using combinations of chromium oxides and then compared to a blue control based on carbon black. When samples were prepared with two different chromium iron oxides, good color matches were possible with dE CMC<0.6 as measured against a blue based on carbon black (Table 3,7). The corresponding infrared reflectance signal for these batches, measured at 980 nm, gave a range of reflectance values from 33.3% R to 47.3% R at 980 nm.(FIG. 2).

TABLE 3
Blue (I)

| Valox ® 325 | | | |
|---|---|---|---|
| PBT | 5 | 6 | 7 |
| A | 0.24 | 0.24 | 0.24 |
| N | 1.55 | 1.55 | 1.55 |
| O | 0.02 | 0.02 | 0.025 |
| D | 0.05 | | |
| E | | 0.05 | |
| B | | | 0.0025 |

### EXAMPLE 3

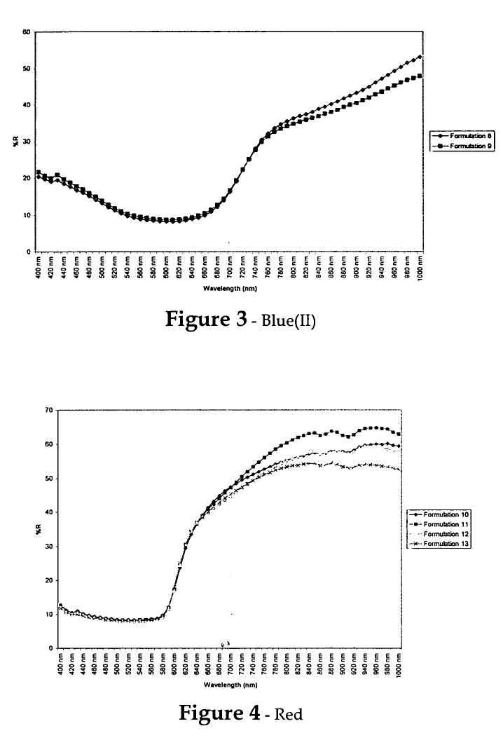

The second blue(II) series was formulated to give infrared resolution by using different commercial grades of manganese rutile brown. This strategy allowed for a color match with dE CMC=0.2 (Table 4,7) and percent reflectance range of reflectance values from 46.7% R to 51.4% R when measured at 980 nm (FIG. 3).

TABLE 4
Blue(II)

| Valox ® 325 | | |
|---|---|---|
| PBT | 8 | 9 |
| A | 0.24 | 0.24 |
| N | 1.55 | 1.55 |
| O | 0.02 | 0.025 |
| I | 0.25 | |
| J | | 0.35 |

### EXAMPLE 4

Red colors were formulated using solvent dyes as the major source of color and appearance. Manganese rutiles and manganese ferrites were added such that final colors were alike while reflection in the IR was different for each composition (Table 5,7, FIG. 4).

TABLE 5
Red

| Valox ® 325 | | | | |
|---|---|---|---|---|
| PBT | 10 | 11 | 12 | 13 |
| A | 0.05 | 0.05 | 0.05 | 0.05 |
| O | 0.4 | 0.34 | 0.34 | 0.34 |
| P | 0.005 | 0.016 | 0.016 | 0.005 |
| H | 0.3 | | | |
| F | | 0.055 | | |
| G | | | 0.075 | 0.06 |
| K | | | | 0.12 |

### EXAMPLE 5

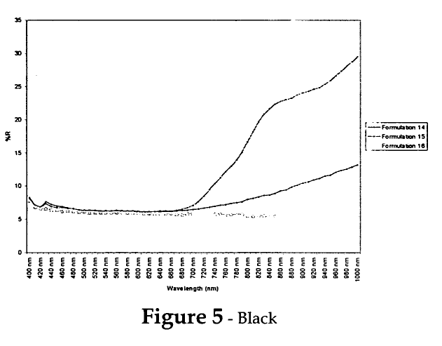

Black color compositions were formulated using chromium iron oxides pigments with combinations of organic colorants. (dE CMC=0.13, reflectance range at 980 nm was 12.5% R to 28.1% R (Table 6,7, FIG. 5).

TABLE 6
Black

| PC/Polyester | | | |
|---|---|---|---|
| blend | 14 | 15 | 16 |
| Q | 0.024 | 0.18 | 0.01 |
| O | 0.017 | 0.092 | 0.15 |
| P | 0.018 | 0.026 | 0.31 |
| E | 0.4 | | |
| D | | 0.5 | |
| C | | | 0.2 |

Diffuse reflectance was acquired on a GretagMacbeth ColorEye 7000A with D65 illumination, 10°observer, dE CMC, specular included, UV excluded, large lens position, large aperture. Samples compared had same gloss level and were therefore measured in specular included mode. The ratio of lightness to chroma in the ellipsoid used to calculate dE CMC was 2:1.

Infrared measurements were made using a Perkin Elmer Lambda 35 equipped with a 50 mm Labsphere.

It is generally accepted that a color tolerancing system based on ellipsoidal volumes of acceptability will provide good correlation to visual assessment. The CMC color space was therefore used to determine if a color was sufficiently matched. The Color Measurement committee of the Society of Dyers and Colorists (CMC) has developed an industry wide accepted mathematical tolerancing system for acceptable color differences which positively correlate with visual assessment of color matches. The delta E CMC value is calculated from CIE 1976 lightness, chroma, and hue difference. Based on our manufacturing experience, when a trial sample is measured against a color standard, an adequate tolerance for overall color is delta E CMC≦1.2.

TABLE 7

| Green | | Blue I | | Blue II | | Red | | Black | |
|---|---|---|---|---|---|---|---|---|---|
| Standard | DE | Standard | DE | Standard | DE | Standard | DE | Standard | DE |
| 3 | CMC | 7 | CMC | 12 | CMC | 10 | CMC | 14 | CMC |
| 1 | 0.84 | 5 | 0.22 | 8 | 0.21 | 11 | 0.47 | 15 | 0.13 |
| 2 | 1.20 | 6 | 0.56 | | | 12 | 0.61 | 16 | 0.41 |
| 4 | 0.54 | | | | | 13 | 0.59 | | |

The figures show the reflectance spectrum of various samples having visible color matches (400 nm to 700 nm) and partial IR spectrum showing significantly different reflectance values at various wavelengths in the spectrum

The figures provide strong evidence of the invention. Up to about 680 nm, the spectra in each color example is extremely close, bordering on congruent in some instances. Above about 680 nm and particularly above about 700 nm, the spectra show significant divergence dependent upon the color components of the individual compositions. These fingerprints are used to denote the source of the process part or material composition. Where there is a match in the IR with the authentic part, the part is genuine as to source. If there is no match, then the part is not genuine. This process is quick, inexpensive and does not use any outside “markers” unnecessary to the performance specification of the part. Previous attempts to achieve authentication involved use of taggants as a marker material. However, taggants can be expensive, may require unique dosing equipment and can have negative interactions with the matrix. Other taggants may first need an external excitation source in order for detection to occur and may lose signal due to degradation or migration.

1. A method for assessing the authenticity of an opaque colored part, which comprises,
a. assessing the visual color of a part and comparing the visible color to the authorized specific color to see if there is a color match,
b. measuring a non-visible electromagnetic reflectance spectrum or portion thereof of the said part and comparing it to the authorized non-visible electromagnetic reflectance spectrum or portion thereof to see if there is an appropriate reflectance match.

2. The method in accordance with claim 1 wherein the visual color is selected from the group consisting of whites black, gray, primary colors, secondary colors, and tertiary intermediate colors.

3. The method in accordance with claim 1 wherein the non-visible electromagnetic spectrum is the infrared.

4. The method in accordance with claim 3 wherein the infrared is the near infrared.

5. The method in accordance with claim 1 wherein there is no appropriate reflectance match in the non-visible electromagnetic spectrum.

6. A method for assessing the authenticity of an opaque colored part which has a visible color match with a standard part which comprises measuring a non-visible electromagnetic reflectance value or portions thereof of the said part and comparing it to the authorized non-visible electromagnetic reflectance spectrum or portion thereof of the standard part to determine if part has authentic reflectance properties.

7. An article comprising a colorant system, said system having an equivalence of the color in visible color space and having non-equivalent reflectance values in another portion of the electromagnetic spectrum such that authentication of the article may be determined.

8. An article according to claim 7 wherein said article comprises an opaque colored part.

9. An article according to claim 8 wherein said part comprises a thermoplastic material.

10. An article according to claim 9 wherein said colorant system comprises an organic or inorganic pigment in an amount from 0.001 percent to about 20 percent by weight based on the total weight of said thermoplastic material.

11. An article according to claim 10 wherein said article includes one or more pigments selected for a desired color match.

12. An article according to claim 11 wherein said selected pigments are additionally selected for spectrum separation in the non-visible spectrum.

13. An article according to claim 12 wherein said non-visible spectrum is infrared.
